(19) United States
(12) Patent Application Publication
(10) Pub. No.: US 2011/0181684 A1
(43) Pub. Date: Jul. 28, 2011

(54) METHOD OF REMOTE VIDEO COMMUNICATION AND SYSTEM OF SYNTHESIS ANALYSIS AND PROTECTION OF USER VIDEO IMAGES

(75) Inventors: Yuri Salamatov, Krasnoyarsk (RU); Alexander Ivanov, Moscow (RU); Vadim Zamuraev, Verkhnyaya Salda (RU)

(73) Assignee: InnovatioNet, Palo Alto, CA (US)

(21) Appl. No.: 13/022,565

(22) Filed: Feb. 7, 2011

(51) Int. Cl. H04N 7/14; G06F 17/28

(52) U.S. Cl. 348/14.07; 704/2; 348/E07.077; 704/E11.001

(57) ABSTRACT

A method for remote video communication, the method including gathering a library of video images of a user, selecting a scenario of communication with an interlocutor, selecting a video image of the user, presenting the video image to the interlocutor, protecting the video image from the interlocutor by defining a degree of a correction, tracing and recognizing characteristic features of a behavior of the interlocutor, defining an emotional state of the user, correcting the emotional state of the user, defining the degree of the correction of the video image of the interlocutor, and providing the video image with a realistic appearance.

### FIELD

The given invention concerns methods of organization of remote video communication between interlocutors with privacy protection of the user, with definition of various emotional and other displays of the interlocutor and with correction of the video image of the user.

### BACKGROUND

The human need for communication is universal. The purpose of communication is to understand other persons. This understanding is a mental modeling of a person (summation of his ideas, feelings, emotions and physical state over time, in the past, present and future). Our ability to predict and/or have influence over the actions of other people depends on the depth of our understanding of them. The importance of this ability is in our social nature.

In human history this recognition occurred during the direct contacts between people and was based on sensory and mental detection. According to research by A. Pease [1], during a conversation only 7% of information is transferred directly by words, 38% by characteristics of the sound and the intonation, and the others 55% of information is transferred by nonverbal means—the speaker's gestures, mimicry, as well as his appearance and environment.

With the invention of written language emerged the possibility of remote recognition. The textual or graphical method of recognition is extremely poor in comparison with direct communication. It is easy for a writer to mask his own thoughts, intentions and desires. The invention of a telephone (audio recognition) further broadened the possibilities of remote recognition, since various characteristics of the voice and lexicon are capable of conveying additional information. With video communication the extent of recognition can approach the level of direct contact. Video communication is an illusion (quasi-) of direct communication.

However, along with its benefits (high level of recognition) video communication introduces certain disadvantages into human communication. These disadvantages are caused by the technical nature of video communication because technical system is interwoven with the human nature of traditional modes of communication. Technical systems have their own (nonhuman) features, such as high accuracy, high optical resolution, the absence of emotions and errors, the possibility of storing, transferring and duplicating of audio-video information, as well as the immediate availability for communication, regardless of the user's preparedness.

During communication, a person performs two functions simultaneously: recognizes the interlocutor and avails himself for recognition, thus solving two problems: while it is possible to recognize the interlocutor, it is also possible to present oneself more advantageously. The usual communication strategy is to penetrate the personal sphere of interlocutor as deeply as possible, while disable the penetrations into one's own personal sphere as much as possible.

Thus, the purpose of communicating using video phone is to achieve penetration into another's privacy (up to the allowed limit or deeper) and preserve one's own privacy, while providing the interlocutor with a favorable image. If all these functions are carried out better than during the direct contact, the level of recognition could be raised above 100%, because the technical systems are better suited for tracing and deciphering video imagery, while protecting the user's privacy, than humans.

Privacy is the informational self-governing. It is the right to control one's own personal information, and the ability to control the instance and the method by which this information is conveyed to others. The person himself has the right to decide on the volume in which to communicate thoughts, feelings and emotions to other people. In video communications, privacy is the personal virtual space.

During video communication between two users there are mutual digital exchanges of audio and video information. Each user controls his flow of exchange. The user can modify and process the information at any site of the video communication channel: from the camera of his videophone to the monitor of the interlocutor's videophone. It was impossible to modify (correct) audio-video information during its transfer in the analog signal flow. For example, in the beginning of the TV development any accidental error in the audio-video image was transmitted out of studio to subscribers, which was extremely unpleasant to the authors, executors and operators of TV-broadcasts. Today, the individual video communication can also bring trouble to its users. For example, a call can come at a time when the user is not prepared to show the caller what he looks like, where he is, or who is near him. By not accepting the call, it is possible to offend a relative or a friend, encourage suspicion in a spouse, or displease a superior. At the same time accepting a video call may harm the user. This controversial situation is directly related with the concept of “privacy”.

The history of the development of this concept is given in [2]: “That the individual shall have full protection in person and in property is a principle as old as the common law; but it has been found necessary from time to time to define anew the exact nature and extent of such protection. Political, social, and economic changes entail the recognition of new rights, and the common law, in its eternal youth, grows to meet the new demands of society. Thus, in very early times, the law gave a remedy only for physical interference with life and property, for trespasses vi et armis. Then the “right to life” served only to protect the subject from battery in its various forms; liberty meant freedom from actual restraint; and the right to property secured to the individual his lands and his cattle. Later, there came recognition of man's spiritual nature, of his feelings and his intellect. Gradually the scope of these legal rights broadened; and now the right to life has come to mean the right to enjoy life,—the right to be let alone; the right to liberty secures the exercise of extensive civil privileges; and the term “property” has grown to comprise every form of possession—intangible, as well as tangible . . . .

From corporeal property arose the incorporeal rights issuing out of it; and then there opened the wide realm of intangible property, in the products and processes of the mind, as works of literature and art, goodwill, trade secrets, and trademarks. Recent notions and business methods call attention to the next step which must be taken for the protection of the person, and for securing to the individual what Judge Cooley calls the right ‘to be let alone’.” Thus, introduction of a videophone demands a new level of solutions to the problems of privacy protection. With the appearance new socio-technical systems, such as video communication, privacy must be protected on the ever more intimate levels. (as parts of the property).

U.S. Pat. No. 6,590,601 provides that to protect privacy in communications via videophone, it is possible to send to the interlocutor a video image (for example, the video image of the user's face) not only generated in real time, but also previously processed video image, or a mix of the two. US application 20100220899 offers a method for processing an available image of the user's face, or a part thereof, for the purpose of reaching the desirable image with appropriate form and color. Such processing can occur in automatic or semi-automatic mode, where the user could control and approve the quality of the image.

US application 20100202689 describes a videophone system for processing of the user's facial images, in which one or several preferred (for example, the most attractive) images are stored. When necessary, one of the preferred images replaces the live video image. In addition, the system stores images of separate facial features and can overlay them onto the live video image. This occurs automatically, as soon as the system will recognize an emotionally significant keyword.

While these technical solutions are useful, they are only a first step in the direction of developing video communication systems where the user controls and adjusts the interaction directly.

### SUMMARY

The main contradiction of using video communication is that the user wishes to learn the true nature of the collocutor, but is also afraid that the collocutor would learn about theirs, and instead try to offer a favorable image.

The process of communication is an exchange of thoughts and emotions.

Thoughts and emotions vary from absolutely sincere to absolutely insincere, or from absolutely true to completely distorted.

Sincerity is appreciated by any society, ethnic group or religious denomination, however within the framework of public norms of any of these groups there is a boundary of allowable correction or camouflage.

Everything within this boundary is privacy. Everything beyond this boundary is deception, which may be unmasked.

Thus, the ideal emotional-sensual video communication is an exchange of audio-visual images within the boundaries of privacy dictated by the society, where the certain level camouflaging the true appearance is allowed and the mutual sincerity and emotional states are detected.

The video image can be interpreted as the others' perception of the user, our public “identity”. This integral concept consists of separate components, in which the external image always reflects the internal content. It can be said that a winning video image, that it is the best variant of self-presentation. Video image is the user's appearance, i.e. style of clothes, hairdo, make-up and accessories, as well as manners, mimicry, gestures and posture.

Video communications bring a new (virtual) component to the centuries-old interpersonal communication process. This component changes the order, borders and possibilities of controlling privacy and image in comparison with traditional direct communication. For example, the possibility of instantly changing or correcting the video image, changes the degree of penetration into one's own privacy and appearance.

Functions of video communication system with respect to privacy and image maintenance include determination of the access zone, correction of video image, decoding of the received video image and protection of one's own video image.

Determination of the access zone depends on the degree of detailing of the transmitted video image (for example, user's face):
intimate zone (display of the face from distance up to 0.5 m);
personal zone (display of the face from distance 0.5-1.2 m);
public zone (display of the face from distance 1.2 m or more, according to the scenario).

“Display” of the user's face means the size of the portrait and the resolution in density pixels per inch.

Correction of video image can also depend on the chosen access zone, for example:
without correction (intimate zone);
partial correction or without correction (a personal zone);
correction on scenarios (a public zone);
replacement of the user's face by another one.

User controls and approves the chosen mode of display of video image.

Typical scenario of video image correction:

a) Display of the standard (“average” of the user's face without finishing of face's features (temporary defects, such as bruises, swellings and bristle and so on are removed out of video image only);
b) Virtual make-up, i.e. improvement of user's face up to a standard (“public” for the given person) without change of real mimicry, sight and involuntary reactions (change of complexion, change of frequency and character of breath, diameter of pupils, swallowing, lick the lips, bare the teeth, perspiration, sweat, shiver and so on);
c) Correction of facial expression, sight and involuntary reactions;
d) Correction of voice intonations;
e) Correction of lexicon;
f) Correction of background, pose, gestures and movements;
g) A choice of a form of conversation (friendly joining, official, resolute, dispute, refusal, soft, friendly advice and etc. with giving helps on the screen “how to lead conversation” with automatic definition of key (bearing) phrases and reactions of the user and the interlocutor.
h) Correction of the user's own deceptions.
i) Correction of voice and video image of the interlocutor with the purpose of forming a conversation scenario in accordance with the user's preferences/wishes, for example, changing a conflict scenario into a neutral one.

The zone of access and scenario automatically engages based on the characteristics of the user's voice (timbre, keywords, etc.)

Options of controlling the functions of a videophone by gestures (displaying one finger, two fingers, etc.), facial expressions (winking) or movement (nod of head) are available.

Function of modifying the nonverbal attributes of an emotional state on pre-recorded (compiled, generated) attributes is available. Such attributes can be “correct” images of the user's face instead of any asymmetry or failure during conversation. For example, to increase the confidentiality of a conversation in the presence of third persons, when the user nods the head (says “yes”) his video image on the interlocutor's video phone shakes its head as if to say “no”.

The nonverbal attributes of an emotional state include mimic attributes (attributes of emotional states, smiles as confusion, asymmetry and untimeliness of facial expressions of emotions, duration of facial expression), paralinguistic and extra-linguistic attributes (detection of pauses, speech mistakes, tone and volume of the voice, speed of speech, interjections, deep breathes and coughing), gesticulation and movements (registration of tension, quantity of gestures, incoordination between the left and right half of body, presence of a point of fixation, emblematical slip of the tongue and manipulations, etc.)

Replacement of the user's video image by the video image of another person is possible. Such video image will need to prerecord the image and speech of that person. It is the easiest to receive such records from relatives and familiar people or to buy prerecorded video images of well-known people (actors, politicians.) To increase the degree of trustworthiness of the substitution of the user's image by other person's, the special program would have to change video and audio images in real time.

After the conversation is complete, the system should replay the fragments where the collocutor behaved unusually (in a positive or negative sense), as well as the fragments with the maximum emotional/sensual weight.

After the conversation, the system should also perform analysis and provide recommendations as to how to behave with the collocutor in the future (contact is desirable/undesirable, to trust/not to trust (percentage), to lead/submit/be equal, frank/closed and etc.)

The system should analyze the library of data records of video-conversations with each person to reveal what has changed in his behavior in regard to the user since the last conversation.

In the preparatory period (adjustment of new videophone to the specific features of the user), filming of the standard face, mimicry, poses and voice for each scenario is performed. Shooting of several backgrounds that are typical to each scenario also is carried out.

The system also provides an option of tracing the brief emotional reactions of the interlocutor and showing the message in the symbolical or textual format about the collocutor's instant reaction. At the completion of a conversation it is possible to turn on the option of detecting the emotional reactions and receiving the true reaction of the interlocutor to each phrase.

The videophone should also have a detector of emotional state of the user with its further correction by music. For example, music has the strongest impact on the center of positive emotions in the human brain, because music influences thalamus (“relay station” of all human emotions and feelings) bypassing the consciousness. Under the influence of music, endorphins (“paradise's hormones”, i.e. a natural narcotic) are produced and in short time the blood vessels extend, an inhibition on the course of nervous trunks is removed and blood supply is improved.

The necessity of correction decoding and removal of correcting signals from the received video image is dictated by the following: life is a chain of actions and reactions. Action is a result of thinking and feeling. The main goal of life success strategy is predicting actions of other people. During a video communication, a collocutor performs the following functional sequence: thought—emotion—mimicry—masking—speech. The goal of the caller on the other side is the opposite: decode speech, mimicry and emotion to reveal the true thought. If the user reveals the true thought of the collocutor he will be able predict his actions.

The videophone must also include a function dedicated to protection against removal of correction, and should send a signal when an attempt of such removal (attempt on violate privacy of the user) is detected. This reveals a new concept in video-privacy—personal virtual space.

Privacy in video communication can be of two types:
Protection of the momentary video image of the user;
Protection of video image (phantom, desirable audio-video image).

Introduction of “sincerity detector” in video communication will require a function for protection against deception by the collocutor.

Deception causes damage to the property (direct material or moral, for example, damage to self-respect).

Protection against deception can be performed in two ways:
display of a stationary image (an instant photo, captured on the screen or recalled from the library of previously recorded images.) Such photos can be modified or changed in any detail;
display of a dynamic image (“live”, instantaneous, real) with simultaneous instant correction of video image.

Privacy in video communication is any audio-video information about the user and variants of its interpretation, transformation and processing, transmitted during a communication session.

The user has the complete right to control and administer his own privacy:
Display to/withhold from the collocutor his real or corrected audio-video image;
To adjust the depth of penetration into his personal virtual space by the collocutor, i.e. allocate a certain degree of detailing (the dimension and resolution of one's own video image displayed on the collocutor's screen) and the accuracy of one's own audio-video image.
Add to audio-video-informational digital flow transmitted from one user any additional information (harmless to the collocutor), for example, marks, watermarks, limitations on ability to record or store the records of the communication session, function of messages' self-destruction, program informing about the user's location on the network, advertising, etc.

Degree of privacy protection and degree of image correction may be combined in any permutation and displayed on the screen as a transmitted image. This image is chosen at the beginning of a conversation, is approved by the user and, mainly, remains unchanged during conversation.

It is necessary to take into account, that the collocutor of the user will also have the ability to correct the image. There are times when the user (for example, a law enforcement officer) would require a true image of the collocutor. For this purpose, system of video communication will require a module for decoding the correction and removing the correcting signals from the received video image. Certainly, this will provide an incentive to design the means of protection against the removal of signal correction removal, and alarming the user about the attempts of such removal. The logic of development of such “opposing” systems (virus—antivirus, protection of money—counterfeiting, rockets—anti-rockets, criminals—law-enforcers) results in the development of constantly advancing methods, principals and technical systems. Usually, such developments proceed in alternating pattern: one of system takes a leap forward and for some time prevails, but then the opposing system improves and surpasses the first one, and so on.

Detector of sincerity in the collocutor (for example, by the symmetry of the right and left halves of the face in displaying the emotion) by comparing the inverses of the reflected halves and displaying the level of sincerity in the interlocutor on the screen (graphically or numerically). Vibrolmage Technology [3]is the system best suited to the purposes of rapid and accurate detection of the level of sincerity. This technology is based on the discovery of a new phenomenon in the human psycho-physiology: complete interconnection of psycho-emotional state with micro-movements of center of gravity in the person, particularly, of the person's head. Micro-movements of the observed points on the user's face are continuously tracked by a video camera and analyzed by a software program. This program determines psycho-emotional state of the subject in every moment in time.

The possibility of detecting whether the audio-video image is being corrected as well as the applications of the detector of sincerity makes the system of video communication the two-edged sword.

Let's assume that: C—correction, UC—uncorrection, T—truth, UT—untruth.

Then interlocutors A and B can be in the following states:

| # | A | B |
|---|---|---|
| 1 | UC + T | UC + T |
| 2 | UC + T | C + T |
| 3 | UC + T | UC + UT |
| 4 | UC + T | C + UT |
| 5 | C + T | UC + T |
| 6 | C + T | C + T |
| 7 | C + T | UC + UT |
| 8 | C + T | C + UT |
| 9 | UC + UT | UC + T |
| 10 | UC + UT | C + T |
| 11 | UC + UT | UC + UT |
| 12 | UC + UT | C + UT |
| 13 | C + UT | UC + T |
| 14 | C + UT | C + T |
| 15 | C + UT | UC + UT |
| 16 | C + UT | C + UT |

Here only the first and the last conditions of collocutors completely coincide: the first is extreme sincere (honest, open) conversation; the last is extreme insincere conversation.

The collocutors can accept one of the following decisions having revealed in which state there is a current conversation:
continue the conversation without change, taking into account the current formed state and drawing appropriate conclusions with respect to the results of the conversation;
offer the collocutor to change one state into another (for example, 1, 2, 5, 8);
end the conversation.

Videophones and the technical systems discussed herein will be improved over time and there will come the moment when the percentage of mistakes in audio-video image detection, emotional state and sincerity will be minimal. The degree of trust the society will place on these systems will increase. The possibility of undetected deceit will decrease significantly. Thus, the general tendency of social changes will manifest itself in inconsistent increase in sincerity. Introduction of videophones enhanced with technical systems discussed herein into general (public) practice will result in improved in social communication (in family, at school, on work, in a public place and etc.).

Men have always hid the deceit and malicious intentions inside their outer shells. These shells will now become transparent. The deceiver will now be forced to pretend to be a sincere person who himself fell victim of deceit, which makes achieving his goals of much more difficult. These videophones will enable automatic introduction services when the system will independently discover video-files uploaded by people whom it will deem suitable based on a certain set of requirements. They will also enable keeping automatic personal video diary, which will record of the most emotionally significant fragments of users' life.

It will become possible to perform delayed analysis of a conversation, because the user's emotional reactions to the same record viewed under different circumstances and in different frames of mind will also be different. There will also be a virtual stylist subsystem, which will take into consideration such factors as sex, age, place, season, weather, rituals, kinds of activity, occupation, fashion, and ethnicity to advise the users with respect to style of clothes, haircut, make-up, accessories, manners, mimicry, gestures and posture suitable to a particular situation. The following is an example of one of possible sequences of actions in using the described videophone system:

1) Call received, caller identified. When the caller dials the user's number, he is not presented with any image until the user identifies the caller and makes the decision on whether to accept the call and, if accepting, on which video-communication scenario to engage. Only after this decision is made, the caller will see the chosen image of the user (statics, photo or video).
2) System determines which of the groups of contacts the caller belongs to. If the caller is unknown to the user the video image will not be displayed. If the user recognizes the caller, than the system determines the degree of accessibility is warranted. This determination is performed not only by the number from which the call originated, but also by the callers' first words (audio-identification).
3) Before the camera engages, the system inquires with the user with respect to possible infringement onto the privacy of others around him.
4) Video communication scenario engages.

### BRIEF DESCRIPTION OF THE DRAWINGS

The foregoing and other objects, features, and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1a depicts the variant of embodiment of the system where all functional subsystems are available to the users (collocutors) on their respective communication devices.

FIG. 1b depicts the variant of embodiment of the system, where all functional subsystems are available to the users (collocutors) on the communication network, off of their respective communication devices.

### DETAILED DESCRIPTION

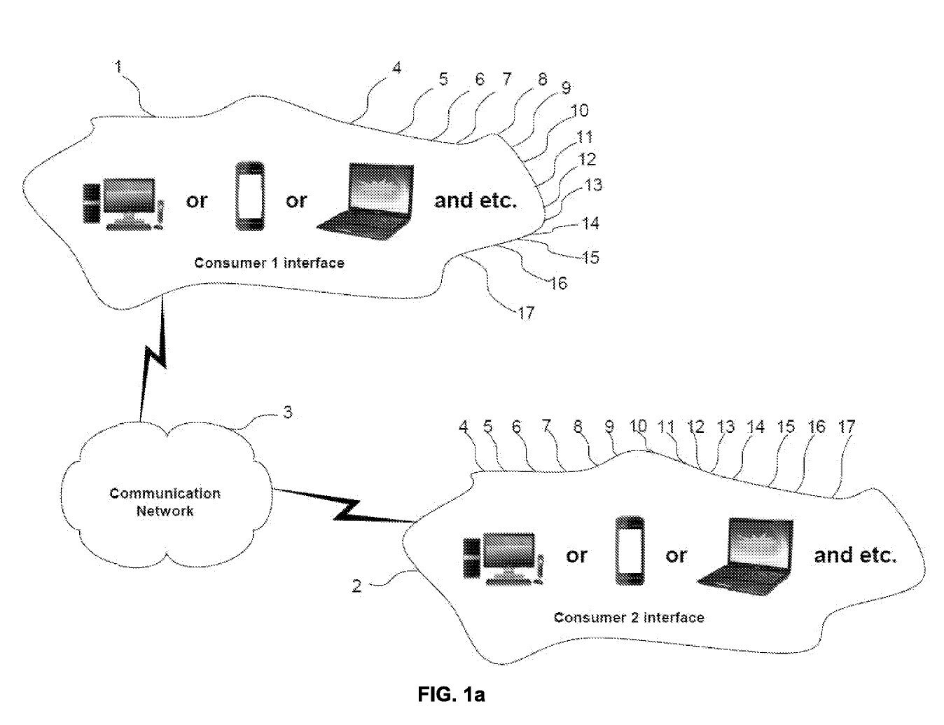

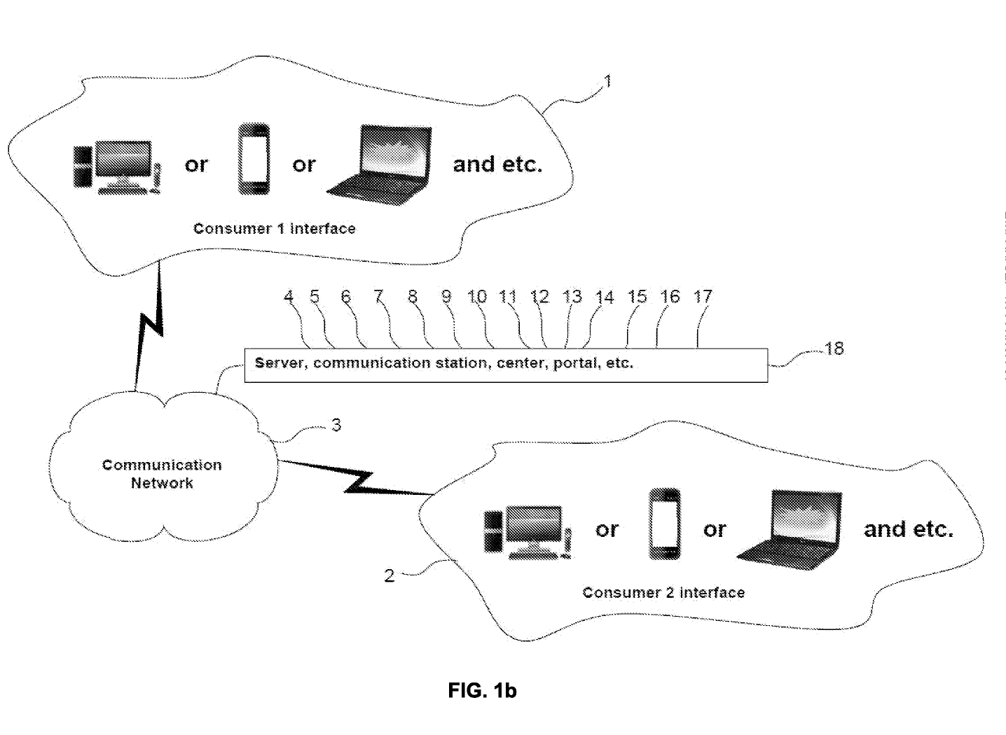

FIG. 1a is a schematic representation of a selected embodiment of the video communication system, where all functional subsystems are available in user's devices 1 and the collocutor's devices 2, which carry out video communication by using communication network 3. The examples of the devices that may be used in the video communication systems include a personal computer, a phone/videophone, a mobile device, or a notebook.

Further referring to the FIG. 1a, the following subsystems are shown:

Subsystem 4, which enables engagement and controls the process of communication with the assistance of communication scenarios;
Subsystem 5, which enables correction and modification of the transmitted image to achieve user-desirable quality and effects;
Subsystem 6, which enables generation and embedding of auxiliary signals (for the control, identification, etc.) into the transmitted image;
Subsystem 7, which enables detection of the degree of image correction in the received (collocutor's) image;
Subsystem 8, which enables detection of the degree of collocutor's sincerity;
Subsystem 9, which enables detection of the collocutor's emotional state;
Subsystem 10, which enables automatic visual psycho-diagnosis;
Subsystem 11, which enables detection and correction of the user's emotional state;
Subsystem 12, the “the virtual stylist” for advising and correcting the users' style of clothes, haircut, make-up, accessories, manners, mimicry, gestures and posture suitable to a particular situation.
Subsystem 13, which enables automatic “introduction services”, where the system will store the user's personal video file and will independently discover video-files uploaded by other people, whom it will deem suitable based on a certain set of requirements
Subsystem 14, which enables keeping an automatic personal video-diary, which records the most emotionally significant fragments of the user's life;
Subsystem 15, which enables composition of emotional summary of video communication session 15;
Subsystem 16, which enables delayed analysis of the video communication session, to detect emotional reaction of the user in the same record, viewed at other times and under different circumstances
Subsystem 17, which enables tracing brief emotional reactions in collocutor for the purpose of reporting and analyzing the collocutor's true reactions to user's each phrase after the termination of video communication session.

FIG. 1b is the schematic representation of the selected embodiment of the video communication system, where all functional subsystems 4 to 17 above, are placed on an external, in relation to users, element 18 of communication network 3. The examples of devices that can be used in video communication as such an element include a server, a communication station, a center, a portal, or any other device.

What is claimed is:

1. A method of remote video communication, the method comprising:
gathering a library of video images of a user;
selecting a scenario of communication with an interlocutor;
selecting a video image of the user;
presenting the video image to the interlocutor;
protecting the video image from the interlocutor by defining a degree of a correction;
tracing and recognizing characteristic features of a behavior of the interlocutor;
defining an emotional state of the user;
correcting the emotional state of the user;
defining the degree of the correction of the video image of the interlocutor and providing the video image with a realistic appearance.

2. The method of claim 1, wherein the library of video images of the user includes real, corrected and background video images of the user.

3. The method of claim 2, wherein the video images of the user correlate with zones of access allowable for the user.

4. The method of claim 3, further comprising one or more of the following zones of access: an intimate zone, the intimate zone displaying the face of the user from a distance of up to 0.5 meters, a personal zone, the intimate zone displaying the face of the user from a distance between 0.5 and 1.2 meters, and a public zone, the public zone displaying the face of the user from a distance over 1.2 meters.

5. The method of claim 4, further comprising a zone of access characterized by a degree of detailing of the video image of the user.

6. The method of claim 1, further comprising interlocutors known to the user as grouped by zones of access and scenarios of communication.

7. The method of claim 6, further comprising a scenario of communication including displaying of the face of the user without refining temporary defects of the face, the temporary defects including a bruise, a swelling and a bristle.

8. The method of claim 6, further comprising a scenario of communication including a virtual make-up, the virtual make-up including an improvement of the face of the user to a user standard.

9. The method of claim 6, further comprising a scenario of communication includes correction of facial mimicry, colors of make-up, sight and involuntary reactions, such as change of complexion, change of frequency and character of breath, diameter of pupils, swallowing, lick the lips, bare the teeth, perspiration, sweat, shiver and so on,

10. The method of claim 6, further comprising a scenario of communication includes correction of voice intonations.

11. The method of claim 6, further comprising a scenario of communication includes correction of lexicon.

12. The method of claim 6, further comprising a scenario of communication includes correction of background, pose, gestures and movements.

13. The method of claim 6, further comprising a scenario of communication includes the definition and choice of desirable form of conversation, such as friendly conversation, official conversation, resolute, dispute, refusal, soft tone, friendly advice with giving recommendations on the screen how to lead conversation, with automatic definition of key phrases and reactions of the user and the interlocutor and with giving of helps on the screen.

14. The method of claim 6, further comprising: the scenario of communication includes correction lies of the user.

15. The method of claim 6, further comprising a scenario of communication includes correction of voice and video image of the interlocutor with the purpose of forming the scenario of communication necessary to the user, for example, transition of the imposed to the user conflict scenario into neutral one.

16. The method of claim 15, further comprising a real voice and video image of the interlocutor are saved into memory for further analysis.

17. The method of claim 1, further comprising a choice of video image occurs in an automatic mode according to the chosen scenario, in a semi-automatic mode with the opportunity to set by user the video image chosen by system or by manual mode.

18. The method of claim 1, further comprising as video image the live picture in real time mode without any correction is used.

19. The method of claim 1, further comprising as video image another person for example, alliance, friends, known actors, politicians or avatar is used.

20. The method of claim 1, further comprising as characteristic features of the interlocutor's behavior the degree of sincerity and emotional state with of the report formation of his reactions on separate phrases after termination of conversation are traced.

21. The method of claim 1, further comprising a definition of the emotional state of the user is carried out on any characteristic audio and video features.

22. The method of claim 1, further comprising a correction of the emotional state of the user is carried out after conversation with the help of playback any audio and video fragments delivering the pleasure to the user.

23. The method of claim 1, further comprising functions controlling of a videophone and controlling of sent contents is carried out by gestures for example, one finger, two fingers, a facial expression for example, winking, movement of a head for example, a nod, rocking.

24. The method of claim 1, further comprising the interlocutor is defined by characteristic features for example, on voice, on words and so on and automatically is turned on the scenario of conversation which was approved earlier by the user.

25. The method of claim 1, further comprising a change of nonverbal features of user's emotional state on beforehand saved or compiled or generated features for example, the true video image of user's face instead of any asymmetry or failure during communication is carried out.

26. The method of claim 1, further comprising under the mutual agreement of interlocutors with the purpose of confidentiality increase of conversation in the video image nonverbal reactions are replaced by opposite, for example, the nod of head yes—yes is replaced by swaying of head no—no at the presence of extraneous people.

27. The method of claim 1, further comprising during conversation the tracing of brief emotional reactions of the interlocutor is carried out and the brief text or symbolical message about his reaction is typed synchronously on the screen.

28. The method of claim 1, further comprising after conversation the sum of fragments of conversation where the interlocutor behaved not as usually in positive or negative sense and fragments with the maximal emotional—sensual coloring is given to the user.

29. The method of claim 1, further comprising the visual psychodiagnosis, analysis of psychical states and characteristics of the interlocutor on external video image appearance with giving results on the screen after the conversation termination are carried out.

30. The method of claim 1, further comprising after conversation the analysis and giving of recommendations how to behave himself with this person in the further contact whether desirable to trust and what degree.

31. The method of claim 1, further comprising the library of data records of video-conversations with each person is created, processing and the analysis of these records is carried out and the conclusion about the changes occurring in communication for the past period is given on the screen of communication device.

32. The method of claim 1, further comprising in the preparatory period adjustment of a new videophone on specific features of the user shooting of the standard user's face, mimicry, poses, voice and background for each scenario is carried out.

33. The method of claim 1, further comprising the videophone has some modes for people with the limited abilities, for example, transformation of speech into the text for hard-of-hearing people.

34. The method of claim 1, further comprising there is an possibility to add to audio-video-informational digital flow going from the user any another information, not making harm to the interlocutor, for example, marks, watermarks, an interdiction on copying, an interdiction on correction removing, a limiting factor of storage period of record, a program of self-destruction, a program informing about the location in the network, advertising and so on.

35. The method of claim 1, further comprising: continuously or periodically the degree of sincerity of the interlocutor is defined and a ratio sincerity/lie of the interlocutor is displayed on the screen graphically or by numerals.

36. The method of claim 1, further comprising having known in what state there is a current conversation, i.e. having defined the ratio sincerity per lie each other, interlocutors choose one of the following decisions:
continue the conversation nothing changing, but thus to take into account the current state and to draw the appropriate conclusions by results of conversation;
offer the interlocutor to replace the state into another one; and
stop conversation.

37. The method of claim 1, further comprising: an automatic introductions service, search video clips in communication networks which are about the people suitable on any parameters, for example, on psychological compatibility, habits is carried out.

38. The method of claim 1, further comprising an automatic personal diary is created on the basis of records of the most emotional fragments of user's life.

39. The method of claim 1, further comprising the postponed analysis of conversation is carried out because of the emotional reaction to the same record viewed under different circumstances, for example, depending on mood, the said words and reactions of the interlocutor can be filled with others sense, values and intentions.

40. The method of claim 1, further comprising: identification of the user his key, code and the access to use videophone is defined by comparison of a live video image with stored one in memory.

41. The method of claim 1, further comprising: as the additive to the background the special or imitating effects of environment, such as a thunder-storm, a downpour, a thunder, noise of the airport, a bark of dog are used.

42. The method of claim 1, further comprising before the beginning of conversation before turning on camera there is a dialogue of the user with system about possibility of privacy infringement of people taking place hereabout, that is informed to the interlocutor and this circumstance can be used by the user as one of ways of a deviation from direct video-contact.

43. The system of synthesis, analysis and protection of video images of interlocutors, the system including devices for video communication between a user and a interlocutor, the devices providing: a privacy of the user and the interlocutor, zones of access, and video images of the user and the interlocutor.

44. The system of claim 43, further comprising a subsystem of scenarios creation and controlling with their help by process of conversation.

45. The system of claim 43, further comprising a subsystem of correction of sent video image with formation of desirable image of the user.

46. The system of claim 43, further comprising a subsystem of generation and embedding into the sent signal video image auxiliary signals for the control, identification and so on.

47. The system of claim 43, further comprising a subsystem of the estimation of degree of correction of the video image by the interlocutor.

48. The system of claim 43, further comprising a subsystem of detecting of sincerity of the interlocutor.

49. The system of claim 43, further comprising a subsystem of detecting of the interlocutor's emotional state.

50. The system of claim 43, further comprising a subsystem of automatic visual psychodiagnosis.

51. The system of claim 43, further comprising a subsystem of detecting and correction of the user's emotional state.

52. The system of claim 43, further comprising a subsystem of the virtual stylist for the correction of behavior, manners and appearance of the user depending on the chosen scenario of conversation.

53. The system of claim 43, further comprising a subsystem of creation, storage and delivering of video-clips about the user into communication network.

54. The system of claim 43, further comprising a subsystem of an automatic personal video-diary for record of the most emotional fragments of life.

55. The system of claim 43, further comprising a subsystem of drawing up of the emotional resume of video communication session.

56. The system of claim 43, further comprising a subsystem of the postponed analysis of video communication session for detecting emotional reaction of the user on the same record viewed in another time and under another circumstances.

57. The system of claim 43, further comprising a subsystem of tracing of brief emotional reactions and typing the message in the text kind with creation the report of true reactions of the interlocutor on each phrase after the termination of video conversation session.
